(19) United States
(12) Patent Application Publication
(10) Pub. No.: US 2013/0263481 A1
(43) Pub. Date: Oct. 10, 2013

(54) GIFT CARD

(71) Applicant: SUPALOCAL LIMITED, London (GB)

(72) Inventor: Obinna Ihenacho Alozie Nwosu, London (GB)

(73) Assignee: Supalocal Limited, London (GB)

(21) Appl. No.: 13/858,337

(22) Filed: Apr. 8, 2013

(30) Foreign Application Priority Data
Apr. 8, 2012 (GB) GB 1206245.1

(51) Int. Cl. B42D 15/02

(52) U.S. Cl. CPC B42D 15/02
USPC 40/124.06

(57) ABSTRACT

A greetings card is disclosed. The card includes a card body 3, a repository 2 and a trigger mechanism 1. The trigger mechanism 1 is actuable by a user to cause ejection of material in the repository.

### FIELD OF THE INVENTION

This invention relates to a greetings card with integrated party popper mechanism.

### BACKGROUND TO THE INVENTION

The demand for new and inventive forms of greeting card is both strong and lucrative. The Greeting Card marketplace is large and growing. As of 2012, according to the UK Greeting Card Association, the market for Greeting Cards was worth £1.4 billion in the UK alone. The problem is that Greeting Card Retailers want new, interesting, and engaging types of greeting cards to satisfy demand.

### STATEMENT OF INVENTION

According to an aspect of the present invention, there is provided a greetings card comprising a card body configured to receive a repository and a trigger mechanism, the card body including a guide to direct the trigger mechanism into a predetermined position in the card body, wherein, when in the predetermined position in the card body, the trigger mechanism is actuable by a user to cause ejection of material from the repository.

The repository and trigger mechanism may comprise a party popper. The trigger mechanism may comprise a pull cord, the guide being configured to present at least a portion of the pull cord to a user for pulling. The trigger mechanism may comprise a pull cord, the guide being configured to guide and support at least a portion of the pull cord in a predetermined direction during pulling.

The repository may include an explosive charge that is actuable by the trigger mechanism. The greetings card may further comprise a compressed gas store operable by the trigger mechanism to release compressed gas into the repository.

The greetings card may further comprise a resilient spring operable by the trigger mechanism to direct a spring force into the repository to cause ejection of material from the repository.

The material may include confetti. The repository may be user-fillable.

The trigger mechanism may comprise a pull tab configured, prior to being pulled, to be substantially aligned with the card body.

The card body may be openable, the trigger mechanism being configured to be actuated upon the card body being opened.

According to another aspect of the present invention, there is provided a greetings card comprising a card body, a repository and a trigger mechanism, wherein the trigger mechanism is actuable by a user to cause ejection of material in the repository.

The repository may be integrated into the card body. The repository may be a substantially flattened ovular shape.

The trigger mechanism may be integrated into the card body.

The present invention seeks to provide a greeting card with an integrated party popper mechanism.

The party popper mechanism will add to the surprise and delight associated with receiving the greeting card. It will also draw attention to the receipt of the card to people near to the recipient of the card. This has the advantage of both increasing the level of interest in the card receiving event and effectively advertising and demonstrating the benefits of the invention.

Preferably, the party popper mechanism in the card will have a trigger that is activated by the recipient pulling a cable, a card or a card attached to a cable. The cable and card could be made of any material, but one example would be string and cardboard.

A variation on the above preference would be that the party popper mechanism in the card will have a trigger that is activated by the recipient opening the card to reveal the message and anything else, such as a gift card, which may be included inside.

A variation on the above would be that the party popper mechanism in the card will have a trigger that is activated by the recipient removing the card from the envelope that it came in.

Preferably, the party popper mechanism is relatively flat so that it will not add too much to the thickness of the greeting card.

Preferably, the party popper mechanism includes a small friction-actuated explosive charge that is triggered by pulling a cable. In one embodiment, the explosive charge blows out confetti, streamers or some other visual and/or olfactory agent such as perfume, flower petals or the like out of a pocket or other repository in the card.

In an alternative embodiment, the mechanism may be powered by compressed air that is released when released by a trigger action. The compressed air acts in the same way as the explosive charge, blowing out some confetti or streamers or the like.

In another embodiment, the explosive charge action or the build-up and expulsion of gas may be caused by mixing two or more chemical agents together that are held separately and mixed together upon actuation of the trigger mechanism.

A greeting card may be provided with a multitude of party popper mechanisms all activated by the same trigger mechanism. Alternatively, a multitude of party popper mechanisms may be activated by a number of trigger mechanisms.

Optionally, the mechanism may be user customizable with an empty aperture or repository being fillable with confetti or similar by the purchaser when writing the card.

Optionally, the card may include a safety feature such as an adhesive label, perforated tab or similar that must be removed in order to “arm” the card and allow the party popper or other mechanism to be triggered. In this way, accidental triggering of the card when writing the card or examining it in a shop can be avoided.

### BRIEF DESCRIPTION OF THE DRAWINGS

Embodiments of the present invention will now be described by way of example only, with reference to the accompanying drawings in which:

FIG. 1 shows a greeting card with the integrated party popper with a card-attached-to-string trigger as viewed normally by the recipient according to an embodiment of the invention.

FIG. 2 shows an embodiment with a party popper mechanism with attached trigger that would be integrated inside the greeting card.

FIG. 3 shows a greeting card and one possible embodiment illustrating a party popper mechanism and trigger mechanism integrated inside the card.

FIG. 4 shows the effect of pulling the trigger mechanism on the greeting card shown in FIG. 3.

FIG. 5 shows a greeting card and another possible embodiment of the popper mechanism and trigger integrated inside the card.

FIG. 6 shows the effect of pulling the trigger mechanism on the greeting card shown in FIG. 5.

### DETAILED DESCRIPTION

FIG. 1 shows a greeting card (3) according to a potential embodiment. The greeting card (3) has a slit in it with a section of a party popper trigger type mechanism (1) visible through the slit. This could be how a recipient would see the greeting card (3) when they receive it. However, it does not need to look exactly like this. It can be seen that the slit for the party popper trigger mechanism (1) could be located at various different positions on the greeting card (3) and could be a different size and shape. It is also possible for the greeting card (3) to be made out of various different materials including but not limited to card, paper, plastic, metal and wood. The greeting card (3) can also come in a variety of sizes and shapes and is not limited to the rectangular shape depicted in FIG. 1.

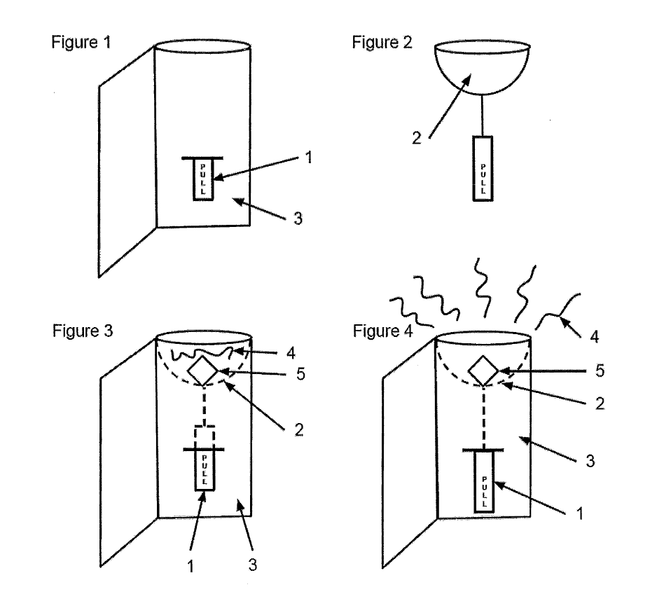

FIG. 2 shows the party popper mechanism (2) that is integrated in the greeting card (3) shown in FIG. 1. The party popper has a trigger mechanism (1) and in FIG. 2 for illustration purposes the whole trigger mechanism (1) and not just the part visible through the slit in FIG. 1 is shown. In this drawing the party popper mechanism (2) is relatively flat and ovular, when viewed from above, compared to the shape of a normal party popper. This is to allow the greeting card (3) in which it will be integrated to be as flat as possible. However, it is not essential that the party popper mechanism (2) be flat and ovular when viewed from above. It could be circular, rectangular or any other shape that may suit the particular implementation. The trigger mechanism (1) can be in a number of forms and is not limited to the style illustrated here. Examples could include but are not limited to the use of buttons, different materials, different shapes, sizes and pulleys. The mechanism also need not be mechanical and could be electronic or electro-optical.

FIG. 3 shows the sample greeting card (3) with the party popper mechanism (2) and trigger mechanism (1) installed. The party popper mechanism (2) and the greeting card (3) are shown transparently. The party popper mechanism (2) has an explosive charge (5) and a space above the charge to store confetti (4). The explosive charge (5) is attached to the trigger mechanism (1). In the drawing shown in FIG. 3 the party popper mechanism (2) is using an explosive charge (5). However, it is possible to use other mechanisms to accelerate the confetti (4) out of the greeting card (3) once triggered such as, but not limited to, compressed air. It is clear to someone skilled in the art to see that sufficient space for the inclusion of a written message and space for a gift card or a pouch for money could easily be made available on the greeting card (3).As an alternative to explosive or compressed air, in one embodiment the trigger mechanism may actuate a resilient spring arrangement to launch confetti or the like. For example, the trigger mechanism may release a hold on a flexed beam, elastic or rubber launch mechanism that apply a force to eject the material from the popper mechanism.

It will be appreciated that the popper mechanism may be varied depending on the expulsion mechanism. For example, an explosive charge may be sufficient to eject the contents trough a retaining barrier over an entrance of the popper. On the other hand, a resilient spring or the like may lack the power of the explosive charge and an alternative arrangement may be needed—for example as well as releasing the resilient spring, the trigger mechanism may also release a latch or other mechanism holding closed a door over the popper mechanism.

FIG. 4 shows the sample greeting card (3) with the party popper mechanism (2) and trigger mechanism (1) installed. The party popper mechanism (2) and the greeting card (3) are shown transparently. The party popper mechanism (2) has an explosive charge (5) and a space above the charge to store confetti (4). The explosive charge (5) is attached to the trigger mechanism (1). In the drawing shown in FIG. 4 the trigger mechanism (1) has been activated. In this example the trigger mechanism (1) is activated by pulling it downward. The triggering of the trigger mechanism (1) in turn causes the explosive charge (5) to explode. This in turn causes the confetti (4) contained in the party popper mechanism (2) to shoot out of the top of the party popper mechanism (2) in the greeting card (3). In this example the confetti (4) comes out of the top of the greeting card (3) but it can be seen that in alternative designs the confetti (4) could be made to come out of the back, either side, bottom or front of the greeting card (3).

FIG. 5 shows a variation of the design of the greeting card (3) with integrated party popper mechanism (2). In this example, the trigger mechanism (1) is actually attached to the greeting card (3) in such a way that, if a recipient opens the greeting card (3) to reveal the information contained inside, they will trigger the explosive charge (5) inside the party popper mechanism (2) and release the confetti (4) inside. It is clear to someone skilled in the art to see that sufficient space for the inclusion of a message and space for a gift card or a pouch for money could easily be made available on the greeting card (3).

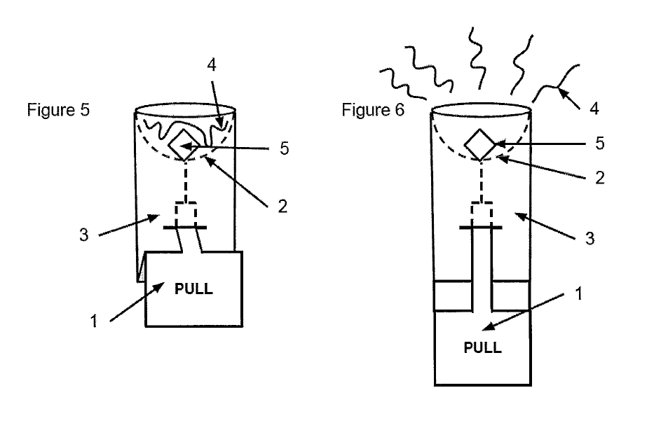

FIG. 6 shows the variation of the design of the greeting card (3) shown in FIG. 5 after it has been opened to reveal the message contained inside. This will trigger the explosive charge (5) inside the party popper mechanism (2) which in turn releases the confetti (4).

It would be clear to someone skilled in the art that many other variations of the design of the greeting card (3) with integrated party popper mechanism (2) could be made to achieve the same effect while still being within the scope of this invention.

1. A greetings card comprising a card body configured to receive a repository and a trigger mechanism, the card body including a guide to direct the trigger mechanism into a predetermined position in the card body, wherein, when in the predetermined position in the card body, the trigger mechanism is actuable by a user to cause ejection of material from the repository.

2. The greetings card of claim 1, wherein the repository and trigger mechanism comprise a party popper.

3. The greetings card of claim 1, wherein the trigger mechanism comprises a pull cord, the guide being configured to present at least a portion of the pull cord to a user for pulling.

4. The greetings card of claim 1, wherein the trigger mechanism comprises a pull cord, the guide being configured to guide and support at least a portion of the pull cord in a predetermined direction during pulling.

5. The greetings card of claim 1, wherein the repository includes an explosive charge that is actuable by the trigger mechanism.

6. The greetings card of claim 1, further comprising a compressed gas store operable by the trigger mechanism to release compressed gas into the repository.

7. The greetings card of claim 1, further comprising a resilient spring operable by the trigger mechanism to direct a spring force into the repository to cause ejection of material from the repository.

8. The greetings card of claim 1, wherein the material includes confetti.

9. The greetings card of claim 1, wherein the repository is user-fillable.

10. The greetings card of claim 1, wherein the trigger mechanism comprises a pull tab configured, prior to being pulled, to be substantially aligned with the card body.

11. The greetings card of claim 1, wherein the card body is openable, the trigger mechanism being configured to be actuated upon the card body being opened.

12. A greetings card comprising a card body, a repository and a trigger mechanism, wherein the trigger mechanism is actuable by a user to cause ejection of material in the repository.

13. The greetings card of claim 12, wherein the repository is integrated into the card body.

14. The greetings card of claim 12, wherein the repository is a substantially flattened ovular shape.

15. The greetings card of claim 12, wherein the trigger mechanism is integrated into the card body.

16. The greetings card of claim 12, wherein the trigger mechanism comprises a pull cord, the guide being configured to present at least a portion of the pull cord to a user for pulling.

17. The greetings card of claim 12, wherein the trigger mechanism comprises a pull cord, the guide being configured to guide and support at least a portion of the pull cord in a predetermined direction during pulling.

18. The greetings card of claim 12, wherein the repository includes an explosive charge that is actuable by the trigger mechanism.

19. The greetings card of claim 12, wherein the repository holds confetti.

20. The greetings card of claim 12, wherein the card body is openable, the trigger mechanism being configured to be actuated upon the card body being opened.
